(19) United States
(12) Patent Application Publication
(10) Pub. No.: US 2019/0122388 A1
(43) Pub. Date: Apr. 25, 2019

(54) HIGH-ACCURACY CALIBRATION SYSTEM AND METHOD

(71) Applicant: Cognex Corporation, Natick, MA (US)

(72) Inventors: David Y. Li, West Roxbury, MA (US); Li Sun, Sudbury, MA (US)

(21) Appl. No.: 15/955,510

(22) Filed: Apr. 17, 2018

Related U.S. Application Data
(60) Provisional application No. 62/486,411, filed on Apr. 17, 2017.

(51) Int. Cl. G06T 7/80; H04N 13/246; H04N 5/247; G06T 7/73

(52) U.S. Cl. CPC G06T 7/85; G06T 7/74; H04N 5/247; H04N 13/246

(57) ABSTRACT

This invention provides a calibration target with a calibration pattern on at least one surface. The relationship of locations of calibration features on the pattern are determined for the calibration target and stored for use during a calibration procedure by a calibrating vision system. Knowledge of the calibration target's feature relationships allow the calibrating vision to image the calibration target in a single pose and rediscover each of the calibration features in a predetermined coordinate space. The calibrating vision can then transform the relationships between features from the stored data into the calibrating vision system's local coordinate space. The locations can be encoded in a barcode that is applied to the target, provided in a separate encoded element, or obtained from an electronic data source. The target can include encoded information within the pattern defining a location of adjacent calibration features with respect to the overall geometry of the target.

### RELATED APPLICATION

The application claims the benefit of co-pending U.S. Provisional Application Ser. No. 62/486,411, entitled HIGH-ACCURACY 3D CALIBRATION TARGET AND METHOD FOR MAKING AND USING THE SAME, filed Apr. 17, 2018, the teachings of which are expressly incorporated herein by reference.

### FIELD OF THE INVENTION

The present invention relates to calibration systems and methods, and calibration objects (targets) used in machine vision system applications

### BACKGROUND OF THE INVENTION

In machine vision systems (also termed herein “vision systems”), one or more cameras are used to perform vision system process on an object or surface within an imaged scene. These processes can include inspection, decoding of symbology, alignment and a variety of other automated tasks. More particularly, a vision system can be used to inspect a workpiece residing in an imaged scene. The scene is typically imaged by one or more vision system cameras that can include internal or external vision system processors that operate associated vision system processes to generate results. It is generally desirable to calibrate one or more cameras to enable it/them to perform the vision task(s) with sufficient accuracy and reliability. A calibration object or target can be employed to calibrate the cameras with respect to an appropriate coordinate space and physical units. By way of example, the image(s) of the workpiece can be characterized by two-dimensional (2D) image pixel data (e.g. x and y coordinates), three-dimensional (3D) image data (x, y and z coordinates) or a hybrid 2.5D image data, in which a plurality of x-y coordinate planes are essentially parallel and characterized by a variable z-height.

The calibration object or target (often in the form of a “plate”) is often provided as a flat structure with distinctive patterns (artwork) made visible on its surface. The distinctive pattern is generally designed with care and precision, so that the user can easily identify each visible feature in an image of the target acquired by a camera. Some exemplary patterns include, but are not limited to, a tessellating checkerboard of squares, a checkerboard with additional inlaid codes at periodic intervals within the overall pattern, which specify feature positions, dot grids, line grids, a honeycomb pattern, tessellated triangles, other polygons, etc. Characteristics of each visible feature are known from the target's design, such as the position and/or rotation relative to a reference position and/or coordinate system implicitly defined within the design.

The design of a typical checkerboard pattern, which is characterized by a tessellated array of crossing lines, provides certain advantages in terms of accuracy and robustness in performing calibration. More particularly, in the two-dimensional (2D) calibration of a stationary object, determining the relative position of individual checkerboard tile corners by edges of the calibration checkerboards is typically sufficient to determine accuracy of the vision system, and as appropriate, provide correction factors to the camera's processor so that runtime objects are measured in view of such correction factors.

By way of further background, calibration of a vision system camera involves mapping the pixels of the camera sensor to a predetermined coordinate system. The target can provide features that define the coordinate system (e.g. the X-Y-axis arrangement of a series of checkerboards), such as 2D codes (also termed “barcodes”) inlaid in the feature pattern, or distinctive fiducials that otherwise define the pattern coordinate system. By mapping the features to camera pixels, the system is calibrated to the target. Where multiple cameras are used to acquire images of all or portions of a calibration target, all cameras are mapped to a common coordinate system that can be specified by the target's features (e.g. X and Y along the plane of the target, Z (height) and rotation θ about the Z axis in the X-Y plane), or another (e.g. global) coordinate system. In general, a calibration target can be used in a number of different types of calibration operations. By way of example, a typical intrinsic and extrinsic camera calibration operation entails acquiring images of the target by each of the cameras and calibrating relative to the coordinate system of the calibration target itself, using one acquired image of the target, which is in a particular position within at least part of the overall field of view of all cameras. The calibration application within the vision processor deduces the relative position of each camera from the image of the target acquired by each camera. Fiducials on the target can be used to orient each camera with respect to the portion of the target within its respective field of view. This calibration is said to “calibrate cameras to the plate”.

Users may encounter certain inconveniences when attempting to calibrate a 2D, 2.5D or 3D vision system using a typical, planar calibration target. Such inconveniences can derive from two sources. Firstly, an accurate calibration target with 3D information requires the manufacture of a calibration target in the micron level, which is not only time-consuming but also costly. Secondly, the calibration of perspective or stereo vision systems requires a calibration target to be imaged in multiple poses that are visible to all cameras. This process is lengthy and error-prone for users, especially when the stereo vision system is complicated (e.g. involving multiple cameras). For example, certain commercially available vision systems composed of four cameras may require twenty or more views of the calibration target to achieve sufficient calibration.

### SUMMARY OF THE INVENTION

This invention overcomes disadvantages of the prior art by providing a calibration target that defines a calibration pattern on at least one (one or more) surface(s). The relationship of locations of calibration features (e.g. checkerboard intersections) on the calibration pattern(s) are determined for the calibration target (e.g. at time of manufacture of the target) and stored for use during a calibration procedure by a calibrating vision system. Knowledge of the calibration target's feature relationships allow the calibrating vision system to image the calibration target in a single pose and rediscover each of the calibration features in a predetermined coordinate space. The calibrating vision system can then transform the relationships between features from the stored data into the calibrating vision system's local coordinate space. The locations can be encoded in a barcode that is applied to the target (and imaged/decoded during calibration), provided in a separate encoded element (e.g. a card that is shipped with the target) or obtained from an electronic data source (e.g. a disk, thumb drive or website associated with the particular target). The target can include encoded information within the pattern that defines a particular location of adjacent calibration features with respect to the overall geometry of the target. In an embodiment, the target consists of at least two surfaces that are separated by a distance, including a larger plate with a first calibration pattern on a first surface and a smaller plate applied to the first surface of the larger plate with a second calibration pattern that is located at a spacing (e.g. defined by a z-axis height) from the first calibration pattern. The target can be two-sided so that a first surface and a smaller second surface with corresponding patterns are presented on each of opposing sides, thereby allowing for 360-degree viewing, and concurrent calibration, of the target by an associated multi-camera, vision system. In other embodiments, the target can be a 3D shape, such as a cube, in which one or more surfaces include a pattern and the relationships between the features on each surface are determined and stored for use by the calibrating vision system.

In an illustrative embodiment, a calibration target is provided, and includes a first surface with a first calibration pattern. A data source defines relative positions of calibration features on the first calibration pattern. The data source is identifiable by a calibrating vision system, which acquires an image of the calibration target, so as to transform the relative positions into a local coordinate space of the vision system. A second surface with a second calibration pattern can also be provided, in which the second surface is located remote from the first surface. The data source, thereby, also defines relative positions of calibration features on the second calibration pattern.

Illustratively, the second surface is provided on a plate adhered to the first surface, or it is provided on a separate face of a three-dimensional object oriented at a non-parallel orientation to the first surface. In an exemplary embodiment, the first calibration pattern and the second calibration pattern are checkerboards. The data source can comprise at least one of (a) a code on the calibration target, (b) a separate printed code and (c) an electronic data source accessible by a processor of the calibrating vision system. The relative positions can be defined by an accurate vision system during or after manufacture of the calibration target, so as to be available for use by the calibrating vision system. The accurate vision system can comprise at least one of (a) stereoscopic vision system, (b) a three-or-more-camera vision system a laser displacement sensor, and (c) a time-of-flight camera assembly, among other types of 3D imaging devices. Illustratively, the calibration target can include a third surface, opposite the first surface with a third calibration pattern and a fourth surface with a fourth calibration pattern, the fourth surface can be located at a spacing above the third surface. The data source can, thereby, define relative positions of calibration features on the first calibration pattern the second calibration pattern, the third calibration pattern and the fourth calibration pattern. Illustratively, the accurate vision system and the calibrating vision system are each arranged to image the calibration target on each of opposing sides thereof. In embodiments, the calibrating vision system is one of a 2D, 2.5D and 3D vision system. Illustratively, at least one of the first calibration pattern and the second calibration pattern includes codes that define relative locations of adjacent calibration features with respect to an overall surface area.

In an illustrative method for calibrating a vision system, a calibration target having a first surface with a first calibration pattern is provided. A data source that defines relative positions of calibration features on the first calibration pattern is accessed. The data source is generated by acquiring at least one image of the calibration target by an accurate vision system. An image of the calibration target is subsequently acquired by the calibrating vision system during a calibration operation by a user. The relative positions by the accurate vision system are transformed into a local coordinate space of the calibrating vision system. Illustratively, a second surface with a second calibration pattern is provided. The second surface is located remote from the first surface and the data source defines relative positions of calibration features on the second calibration pattern.

In an illustrative method for manufacturing a calibration target at least a first surface with a predetermined first calibration pattern is provided. An image of the first surface is acquired, and calibration pattern features are located thereon. Using the located calibration features, a data source is generated, which defines relative positions of calibration features on the first calibration pattern. The data source is identifiable by a calibrating vision system acquiring an image of the calibration target so as to transform the relative positions into a local coordinate space of the vision system. Illustratively a second surface is provided, with a second calibration pattern positioned with respect to the first surface. The second surface is located remote from the first surface and the data source defines relative positions of calibration features on the second calibration pattern. The second surface can be provided on a plate adhered to the first surface, or the second surface can be provided on a separate face of a three-dimensional object oriented at a non-parallel orientation to the first surface. Illustratively, the first calibration pattern and the second calibration pattern can be checkerboards. In an exemplary embodiment, a third surface is provided, opposite the first surface with a third calibration pattern. A fourth surface with a fourth calibration pattern is applied to the third surface. The fourth surface is located at a spacing above the third surface, and the data source, thereby, defines relative positions of calibration features on the first calibration pattern the second calibration pattern, the third calibration pattern and the fourth calibration pattern. The data source can be provided in at least one of (a) a code on the calibration target, (b) a separate printed code, and (c) an electronic data source accessible by a processor of the calibrating vision system.

### BRIEF DESCRIPTION OF THE DRAWINGS

The invention description below refers to the accompanying drawings, of which:

FIG. 1 is a diagram of an overall vision system arrangement undergoing a calibration process using a calibration target and associated stored calibration target feature relationship data in accordance with an exemplary embodiment;

FIG. 2 is a side vise of a two-sided, multi-surface calibration target in accordance with the exemplary embodiment of FIG. 1;

FIG. 3 is a flow diagram of a procedure for analyzing a manufactured calibration target and generating stored calibration target feature relationship data therefrom using a highly accurate vision system, according to an exemplary embodiment;

FIG. 4 is an exemplary embodiment of a three-camera, 3D vision system for generating highly accurate calibration target feature relationship data according to the procedure of FIG. 3;

FIG. 5 is a flow diagram of a procedure for calibrating a vision system using the calibration target and associated stored feature relationship data generated in the procedure of FIG. 3, according to an exemplary embodiment;

FIG. 6 is a more detailed flow diagram of a procedure for reading a code applied to the calibration target in the procedure of FIG. 5, and decoding the stored feature relationship data therefrom, according to an exemplary embodiment;

FIG. 7 is a partial perspective view of a calibration target, according to an alternate embodiment, having at least three stacked surfaces each containing a calibration pattern thereon; and

FIG. 8 is a perspective view of a calibration target, according to another alternate embodiment, defining a 3D shape (e.g. a cube) with calibration patterns applied to at least two discrete surfaces thereof.

### DETAILED DESCRIPTION

### I. System Overview

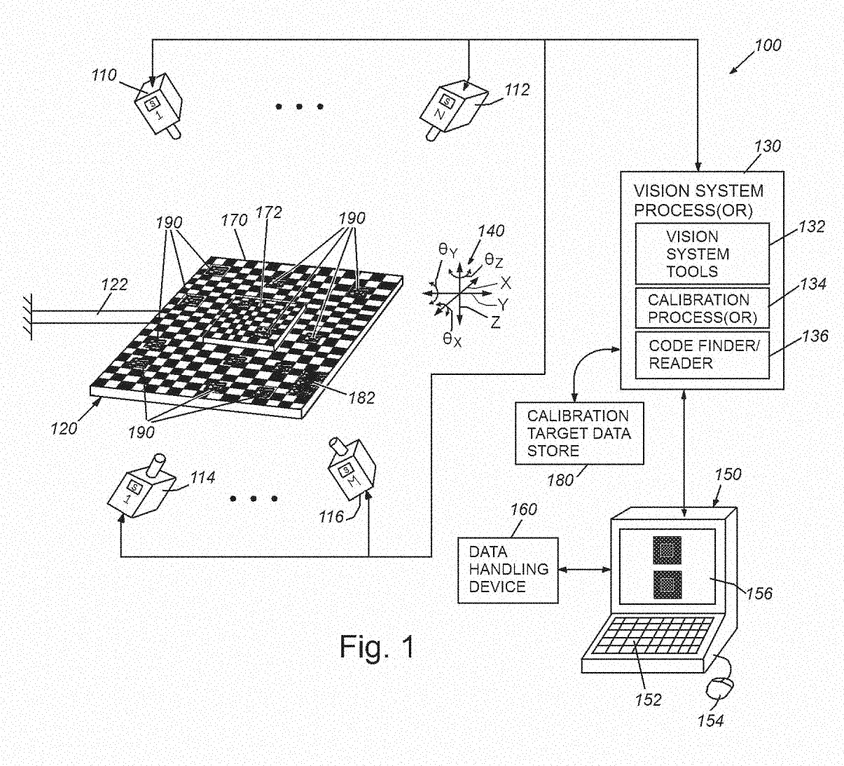

FIG. 1 shows a vision system arrangement 100 consisting a plurality of cameras 1-N (110, 112) and 1-M (114, 116), respectively on each of at least two sides of a calibration target 120 according to an exemplary embodiment. The cameras 110-116 are arranged to acquire an image some or all of the calibration target 120 in the overall scene. The target 120 can be supported by any acceptable mechanism (e.g. rod or bracket 122) that allows the pattern to be viewed. The number of cameras, and their orientation relative to the images scene is/are highly variable in alternate arrangements. In this embodiment, each side consists of at least two cameras and typically, at least four. In other embodiments, each side—or only one side—can be imaged by single camera, or more than four, as appropriate. The cameras 110-116 are arranged to allow for triangulation, using known techniques, so as to generate three-dimensional (3D) representations or the imaged surface. In alternate embodiments, the single-optic cameras depicted can be substituted with one or more other types of camera(s), including, but not limited to, laser displacement sensors, stereoscopic camera(s), LIDAR-based (more generally, range-finding) camera(s), time-of flight camera(s), etc.

The camera(s) 110-116 each include an image sensor S that transmits image data to one or more internal or external vision system processor(s) 130, that carry out appropriate vision system processes using functional modules, processes and/or processors. By way of non-limiting example, the modules/processes can include a set of vision system tools 132 that find and analyze features in the image—such as edge finders and contrast tools, blob analyzers, calipers, etc. The vision system tools 132 interoperate with a calibration module/process 134 that handles calibration of the one or more cameras to at least one common (i.e. global) coordinate system 140. This system can be defined in terms of Cartesian coordinates along associated, orthogonal x, y and z axes. Rotations about the axes x, y and z can also be defined as θₓ, θ_{y} and θ_{z}, respectively. Other coordinate systems—such as polar coordinates, can be employed in alternate embodiments. The vision system process(or) 130 can also include an ID/code finding and decoding module 136, that locates and decodes barcodes and/or other IDs of various types and standards using conventional or custom techniques.

The processor 130 can be instantiated in a custom circuit or can be provided as hardware and software in a general purpose computing device 150 as shown. This computing device 150 can be a PC, laptop, tablet, smartphone or any other acceptable arrangement. The computing device can include a user interface—for example a keyboard 152, mouse 154, and/or display/touchscreen 156. The computing device 150 can reside on an appropriate communication network (e.g. a WAN, LAN) using a wired and/or wireless link. This network can connect to one or more data handling device(s) 160 that employ the vision system data generated by the processor 130 for various tasks, such a quality control, robot control, alignment, part accept/reject, logistics, surface inspection, etc.

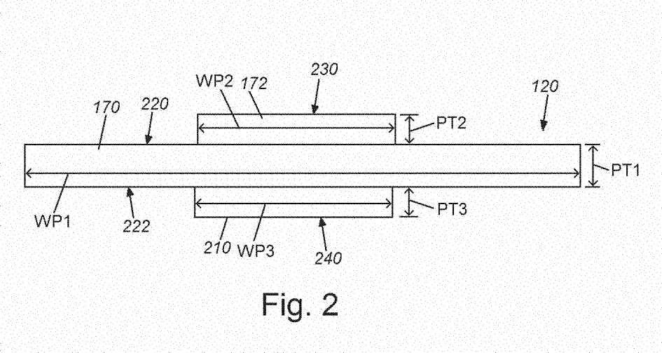

The calibration target 120 of the exemplary arrangement is one of a variety of implementations contemplated herein. In an alternate embodiment, the target can consist of a plate with a single exposed and imaged surface and an associated artwork/calibration pattern (for example, a checkerboard of tessellating light and dark squares). However, in the depicted example, the calibration target consists of a plurality of stacked plates 170 and 172, each with a calibration pattern applied thereto. The method of application of the pattern is highly variable—for example screen-printing or photolithography can be employed. In general the lines defining the boundaries of features and their intersections is crisp enough to generate an acceptable level of resolution—which depending upon the size of the overall scene can be measured in microns, millimeters, etc. In an embodiment, and as depicted further in FIG. 2, the calibration target 120 consists of three stacked plates 170, 172 and 210. The central plate 170 has the largest area and extends across the depicted width WP1, while the two stacked plates 172, 210 on each of the opposing surfaces of the central plate 170 have a small area and width, WP2 and WP3, respectively. The opposing surfaces 220 and 222 of the central plate are separated by a thickness TP1 that can be any acceptable value (e.g. 1-50 millimeters). As described, each surface 220 and 222 can include an exemplary calibration pattern. Thus, the calibration features in each pattern are disposed at a (e.g. z-axis) height-spacing of TP1. The stacked plates 172 and 210 each define a respective thickness TP2 and TP3, so that their respective surfaces/calibration patterns 230 and 240 are disposed at a corresponding spacing from the underlying surface 220 and 222. These spacings generate a z-axis dimension for the features in addition to the x-y axis dimensions defined by each surface calibration pattern. Thus, the calibration target can effectively provide feature information for 3D calibration of the vision system on each side thereof.

The plates 170, 172 and 210 can be assembled together in a variety of manners. In a basic example, the smaller-area plates 172, 210 are adhered, using an appropriate adhesive (cyanoacrylate, epoxy, etc.) to the adjacent surface 220, 222 of the central plate in an approximately centered location. Parallelism between surfaces 230, 220, 222 and 240 is not carefully controlled, nor is the centering of the placement of the smaller plates on the larger plate. In fact, the introduction of asymmetry and skew can benefit calibration of the calibrating vision system (100), as described generally below.

Notably, the relationship between features in three dimensions is contained in a set of data 180, which can be stored with respect to the processor in association with the particular calibration target 120. The data can consist of a variety or formats. For example the data 180 can consist of the location of all (or a subset of all) calibration features in the calibration target 120, or groups of features. The data can be obtained or accessed in a variety of manners. As shown, a 2D barcode (e.g. a DataMatrix ID code) 182 can be provided to a location (e.g. an edge) of the calibration target 120 so that it is acquired by one or more camera(s) of the vision system and decoded by the processor 130 and module 136. Other mechanisms for providing and accessing the data 180 can include supplying a separate label or card with the shipped target 120 with a code that is scanned, downloading the data from a website in association with a serial number (or other identifier) for the target, providing the data in a disk, flash memory (thumb drive), or other electronic data storage device, etc.

### II. Generating Calibration Target Feature Relationship Data

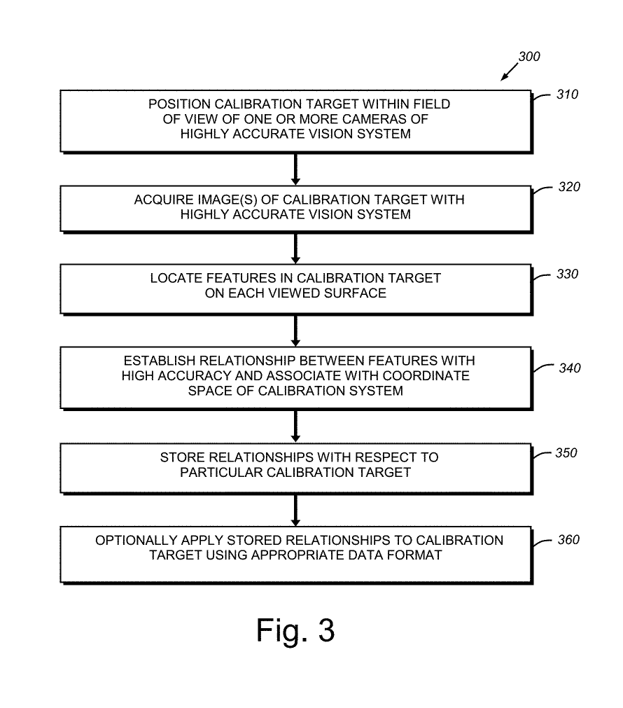

The data that describes the relationship of calibration pattern features for an exemplary calibration target is generated in accordance with the procedure 300 of FIG. 3. In general, the manufacturing tolerance of the target can be reduced significantly if the relationship (e.g. 2D or 3D coordinates) in the associated target coordinates are known and available for use in the calibrating vision system. These relationships can be derived by analyzing the features with a highly accurate vision system. By “highly accurate” (or simply, “accurate”) it is meant that the vision system can deliver relationship data that is sufficient to ensure that any transformation of the coordinates into the calibrating vision systems' coordinate system are within acceptable tolerance for the task being performed by the calibrating vision system in runtime. Thus, by way of example, if the vision system required micron-level-tolerance, the highly accurate vision system returns relationship data in the sub-micron range.

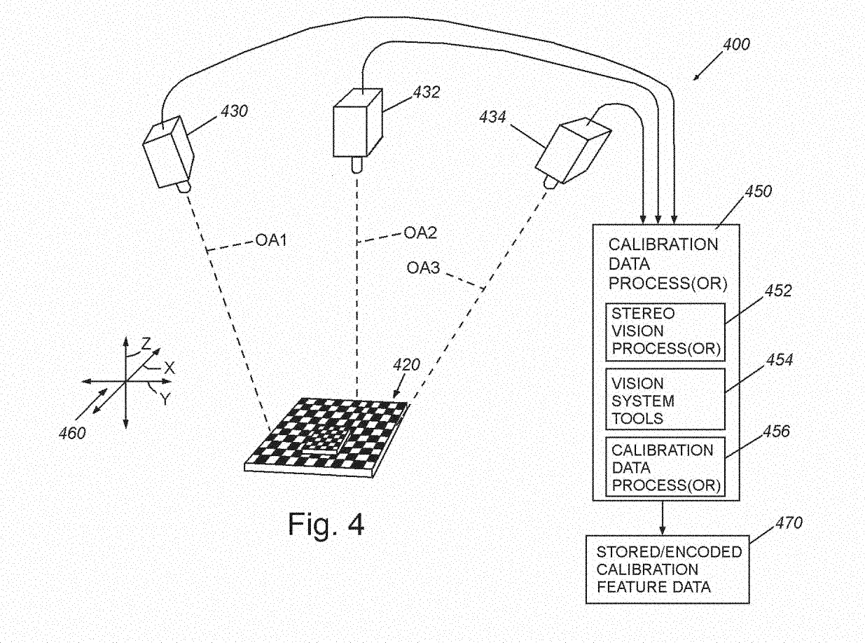

In step 310 of the procedure 300, the manufactured calibration target (according to any of the physical arrangements described herein) is positioned within the field of view of a highly accurate vision system. A stereoscopic vision system with one or more stereo camera assemblies is one form of implementation. However, highly accurate vision systems can be implemented using (e.g.) one or more laser displacement sensors (profilers), time-of-flight cameras, etc. In an embodiment, shown in FIG. 4, an arrangement 400 of a highly accurate vision system for imaging one side of the target 420. The vision system arrangement 400 includes three cameras 430, 432 and 434 arranged at non-parallel optical axes OA1, OA2 and OA3, respectively, that are oriented predetermined relative angles. These three cameras allow for triangulation of features from three perspectives, thereby increasing the accuracy over a conventional stereoscopic system—that is, each camera can be triangulated with two others, and the results are combined/averaged. The image information from each camera 430, 432 and 434, is acquired (step 320 in FIG. 3), and transmitted to a calibration data generation module vision system process(or) 450. The data is processed by a stereo vision module/process(or) 452, in combination with vision system tools that locate and resolve features (step 330 in FIG. 3) in each camera's image and determine their relative position (e.g., true relative positions) within the 3D coordinate space 460 through triangulation (step 340 in FIG. 3). That is, each camera generates a planar (x-y) image. Knowledge of the relative angle of each camera with the other camera allows the same feature in each x-y image to be provided with a z-axis height. The 3D coordinates for the data are provided to a calibration data module/process(or) that associates the coordinates with features and (optionally) generates a stored or encoded set 470 of feature calibration data (step 350 in FIG. 3). This set can include coordinates for each relevant feature in the target 420 and/or relative arrangements of features to one or more reference points (e.g. the orientation of lines to a corner, fiducial, etc. The data set 470 can be printed into one or more encoded ID labels that are applied to or shipped with the target 420 to a user (step 360 in FIG. 3). Alternatively, it can be made available for download into the user's vision system, or delivered to the user by other mechanisms clear to those of skill. Note that a calibration plate and method for use is shown and described by way of useful background in commonly assigned U.S. Pat. No. 9,230,326, entitled SYSTEM, METHOD AND CALIBRATION PLATE EMPLOYING EMBEDDED 2D DATA CODES AS SELF-POSITIONING FIDUCIALS, issued Jan. 5, 2016, by Gang Liu, the teachings of which are incorporated herein by reference.

### III. Calibration Process Using Target and Feature Relationship Data

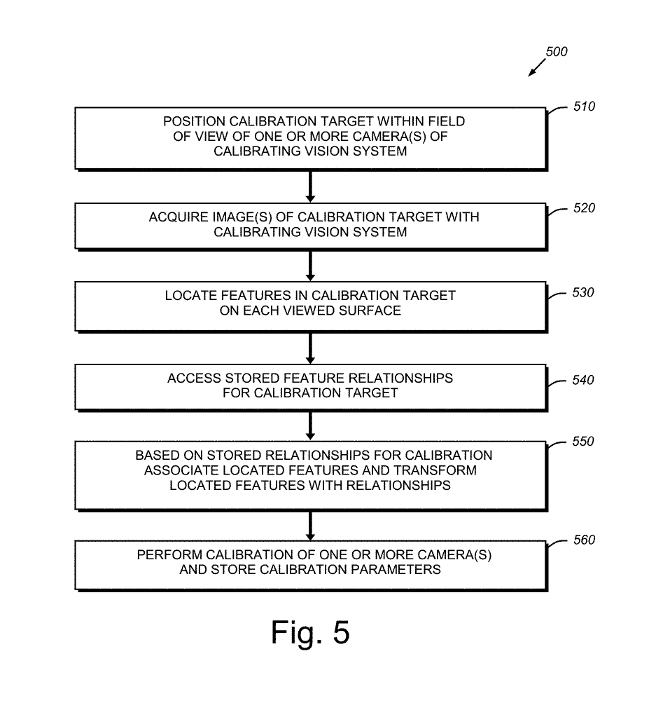

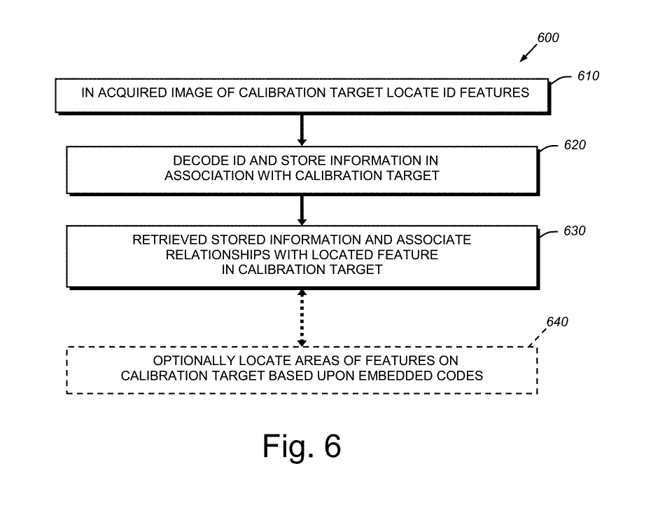

FIGS. 5 and 6 collectively describe a procedure, 500 and 600, respectively for calibrating a vision system (termed the “calibrating vision system”) using a calibration target and associated feature relationship data in accordance with this invention. In step 510 of FIG. 5, the calibration target (in accordance with any structural example contemplated herein) is positioned within the field of view of the vision system—consisting of one or more camera(s) (operating according to an appropriate mechanism, such as conventional optics, telecentric optics, laser displacement, time of flight, etc.). The camera(s) can be oriented to image the target from one side or multiple (e.g. opposing) sides. Image(s) from respective camera(s) are acquired in step 520, typically concurrently and the acquired image data is transmitted to the vision system process(or). Features in each image are located using vision tools (e.g. edges, corners, etc.), and associated with the camera's coordinate system in step 530.

In the procedure 500, information related to the relationship of calibration features (e.g., true relative positions) on the specific calibration target is accessed—either from storage or by reading an ID code on the target (among other mechanisms), in step 540. Referring now to FIG. 6, a procedure 600 for reading an exemplary, applied ID code containing the feature relationship data of the calibration target is shown. The ID code is located on the target, based upon scanning of a known location or region to which the ID is applied, or more generally, searching for ID features using (e.g.) conventional ID finding and decoding processes (step 610). The procedure 600 decodes the found ID, and stores the decoded information in a memory of the vision system processor in a manner associated with the imaged calibration target in step 620. In various embodiments, the ID can encode feature location coordinates or other relationships directly, or can include identifiers that allow retrieval of coordinates from other sources—such as a downloadable database.

In step 630, the retrieved feature relationship data in the exemplary procedure 600 is associated with the actual located features (e.g., measured relative positions) in the image of the calibration target (see also, step 530 in FIG. 5), and, in accordance with step 550 (FIG. 5), the calibration module/process(or) transforms the located features to the known positions of the features in the target from the relationship data so as to transform the relative positions into a local coordinate space of the vision system (including one or more cameras). That is, the calibration process determines which features located in the calibration target by the calibrating vision system correspond to features in the relationship data. This correspondence can be accomplished by registering a fiducial on the target with the location of same fiducial in the relationship data, and then filling in surrounding features in accordance with their relative position versus the fiducial. Note that in various embodiments, the calibration target can include fiducials embedded at predetermined locations within the artwork, each of which references a portion of the overall surface. The fiducials can comprise (e.g.) IDs, such as DataMatrix codes with details about the underlying features (for example, number, size and location of checkerboard corners). See, for example, IDs 190 on the surface of the calibration target 120 in FIG. 1. Optional step 640 in FIG. 6 describes the finding and reading of such embedded codes. This arrangement can be desirable, for example, where parts of the calibration target are obscured to one or more cameras or the cameras' field of view is smaller than the overall surface of the target so that certain cameras image only a portion of the overall target. The embedded IDs allow the vision system processor to orient the separate views to the global coordinate system and (optionally) register the partial views into a single overall image of the target.

In step 560 of the calibration procedure 500 of FIG. 5, the transformed features are stored as calibration parameters for each camera in the vision system (including one or more cameras), and used in subsequent runtime vision system operations.

### IV. Alternate Calibration Target Arrangements

The above-described calibration target is depicted as a one-sided or two sided plate structure with two sets of 2D features stacked one atop the other with the top plate having a smaller area/dimensions than the underlying, bottom plate so that features from both plates can be viewed and imaged. In alternate embodiments, a single layer of features—with associated stored representations can be employed. This is a desirable implementation for 2D (or 3D) calibration, particularly in arrangements where it is challenging for the vision system to image all features on the plate accurately during calibration. Roughly identified features on the imaged target can be transformed into an accurate representation of the features using the stored/accessed feature relationships.

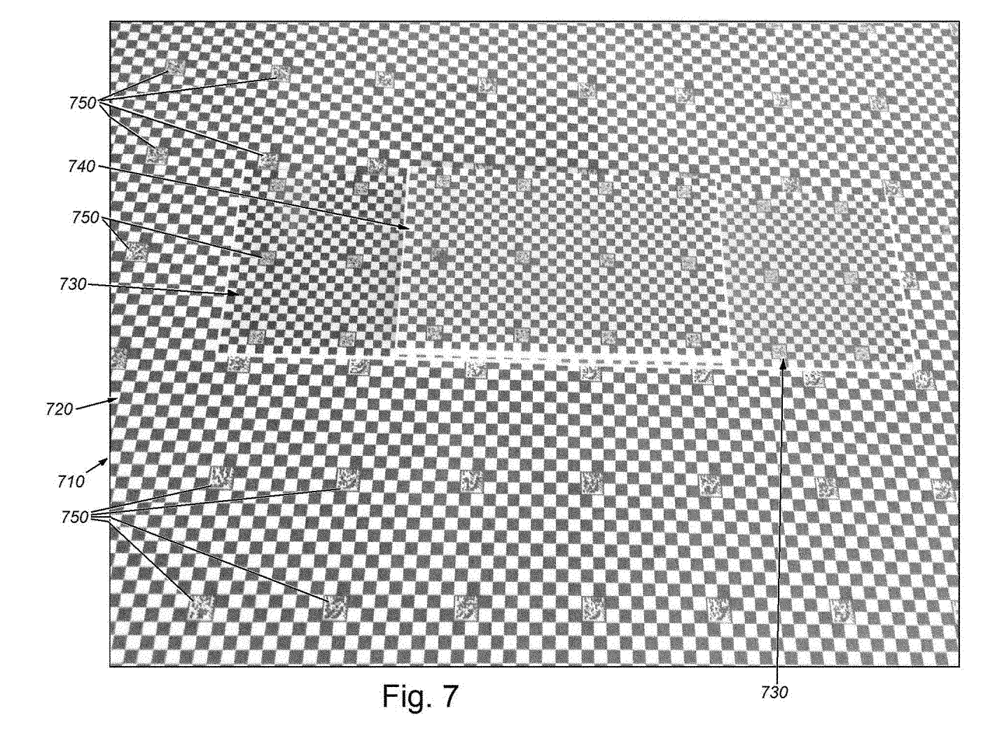

Other calibration target embodiments can employ more than two stacked sets of 2D features. FIG. 7 shows a partial view of an exemplary calibration target 710 that includes a base plate 720, a smaller-dimension, middle plate 730 and an even-smaller-dimension top plate 740. The arrangement is pyramidal so that features on each plate can be viewed and imaged by the camera. Note that the stacking of the plates need not be symmetrical or centered. So long as features are stacked in some manner, allowing spacing along the z-axis (height) dimension, then the target can fulfill the desired function. One alternate arrangement can be a step pattern. More than three plates can be stacked in alternate embodiments and the target can provide multiple stacked plates on each of opposing sides of the arrangement. Note that the above-described embedded ID fiducials 750 are provided to identify the location of adjacent features in the overall surface.

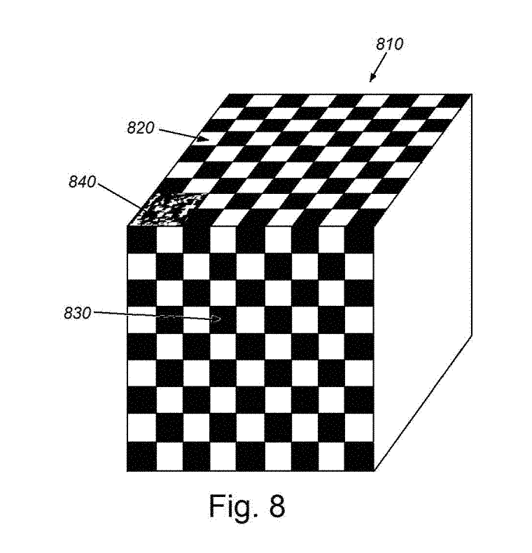

In another alternate arrangement, the calibration target can comprise a polyhedron—such as a cube 810 as shown in FIG. 8. In this embodiment, two or more orthogonal faces 820 and 830 of this 3D object include calibration patterns. At least one of the surfaces 820 is shown including an ID label 840 with feature relationship data that can be read and decoded by the vision system. In an embodiment the sides can be arranged for 360-degree viewing and calibration. Note that in any of the embodiments, an ID label can be located at any appropriate location on the calibration target or at multiple locations.

### V. Conclusion

It should be clear that the above-described calibration target and method for making and use provides a highly reliable and versatile mechanism for calibrating 2D and 3D vision systems. The calibration target is straightforward to manufacture and use, and tolerates inaccuracies in the manufacturing and printing process. Likewise, the target allows for a wide range of possible mechanisms for providing feature relationships to the user and calibrating vision system. The target also effectively enables full 360-degree calibration in a single image acquisition step.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 1-2%) of the system. Note also, as used herein the terms “process” and/or “processor” should be taken broadly to include a variety of electronic hardware and/or software based functions and components. Moreover, a depicted process or processor can be combined with other processes and/or processors or divided into various sub-processes or processors. Such sub-processes and/or sub—processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Also, while various embodiments show stacked plates, surfaces can be assembled together using spacers or other distance-generating members in which some portion of the plate is remote from contact with the underlying surface. Accordingly, this description is meant to be taken only by way of example, and not to otherwise limit the scope of this invention.

What is claimed is:

1. A method for generating an image transform that maps calibration features into a local coordinate space of a vision system, comprising the steps of:
acquiring a first image of a first surface of a calibration target and a second surface of the calibration target, the first surface having a first calibration pattern and the second surface having a second calibration pattern;
identifying measured relative positions of calibration features from the first image;
identifying true relative positions of calibration features from at least one data source that defines true relative positions of calibration features on the first calibration pattern and the second calibration pattern, the data source being identifiable by a calibrating vision system acquiring an image of the calibration target; and
generating the image transform, from the true relative positions and measured relative positions, that transforms the measured relative positions into the local coordinate space of the vision system.

2. The method of claim 1, wherein acquiring the first image includes a third surface of the calibration target and a fourth surface of the calibration target, the third surface having a third calibration pattern and the fourth surface having a fourth calibration pattern.

3. The method of claim 1, wherein the vision system comprises one camera.

4. The method of claim 1, wherein the data source comprises at least one of (a) a code on the calibration target, (b) a separate printed code, or (c) an electronic data source accessible by a processor of the calibrating vision system.

5. The method of claim 1, wherein the first surface and the second surface are separated by a distance.

6. The method of claim 1, wherein the calibrating vision system is one of a 2D, 2.5D and 3D vision system.

7. The method of claim 1, wherein the first image is at least one of a 2D image or a 3D image.

8. The method of claim 1, wherein the measured relative positions comprise 2D or 3D coordinates.

9. A method for generating an image transform that maps calibration features into a local coordinate space of a vision system, comprising the steps of:
acquiring a plurality of images of a first surface of a calibration target, the first surface having a first calibration pattern;
identifying measured relative positions of calibration features from at least one image of the plurality of images;
identifying true relative positions of calibration features from at least one data source that defines true relative positions of calibration features on the first calibration pattern, the data source being identifiable by a calibrating vision system acquiring a plurality of images of the calibration target; and
generating the image transform, from the true relative positions and measured relative positions, that transforms the measured relative positions into the local coordinate space of the vision system.

10. The method of claim 9, wherein acquiring the plurality of images includes a second surface of the calibration target, the second surface having a second calibration pattern.

11. The method of claim 10, wherein the first surface and the second surface are separated by a distance.

12. The method of claim 9, wherein the vision system comprises a plurality of cameras.

13. The method of claim 9, wherein the data source comprises at least one of (a) a code on the calibration target, (b) a separate printed code, or (c) an electronic data source accessible by a processor of the calibrating vision system.

14. The method of claim 9, wherein the calibrating vision system is one of a 2D, 2.5D and 3D vision system.

15. The method of claim 9, wherein the plurality of images image are at least one of a plurality of 2D images or a plurality of 3D images.

16. The method of claim 9, wherein the measured relative positions comprise 2D or 3D coordinates.

17. A system for generating an image transform that maps calibration features into a local coordinate space of a vision system, comprising:
a processor that provides a plurality of images of a first surface of a calibration target, the first surface having a first calibration pattern;
a measurement process that measures relative positions of calibration features from at least one of the plurality of images;
a data source that defines true relative positions of calibration features on the first calibration pattern, the data source being identifiable by a calibrating vision system acquiring a plurality of images of the calibration target; and
an image transformation process that transforms the measured relative positions into the local coordinate space of the vision system based on the true relative positions.
